(19) United States
(12) Patent Application Publication
(10) Pub. No.: US 2009/0309739 A1
(43) Pub. Date: Dec. 17, 2009

(54) Detecting and Notifying of Drowning Conditions in a Swimmer

(76) Inventors: Oren EZER, Tel Aviv (IL); Yaniv BANIN, Raanana (IL); Guy ALMOG, Tel Mond (IL)

Correspondence Address: The Law Office of Michael E. Kondoudis, 888 16th Street, N.W., Suite 800, Washington, DC, 20006, US

(21) Appl. No.: 12/141,069

(22) Filed: Jun. 17, 2008

(51) Int. Cl. G08B 23/00

(52) U.S. Cl. 340/573.6

(57) ABSTRACT

A life saving device, system and method arranged for detecting drowning conditions and pre-conditions in a swimmer within a body of water. The device comprises at least one movement sensor, an optical sensor and a pulse sensor wherein all sensors being in direct communication with the swimmer's body and further coupled to a processing unit which is coupled in turn to a wireless data transference unit. The movement sensors are arranged for identifying bodily movements patterns and orientation, the optical sensor is arranged for sensing oxygen level in the blood of the swimmer, the pulse sensor is arranged for sensing the heartbeat rate of the swimmer and the processing unit is arranged to process data from all sensors and determine drowning conditions and pre-conditions according to predefined parameters wherein the parameters are swimmer specific and exhibit a learning process.

### TECHNICAL FIELD

The present invention relates to appliances pertaining to water related recreational activities and, more particularly, to an apparatus, method and system for detecting and notifying of drowning conditions in a person within a body of water.

### BACKGROUND OF THE INVENTION

Drowning accidents claim the life of thousands of people each year. While the reasons for drowning are varied, there is a wide consensus that drowning is an evolving process along time that is characterized by well defined preconditions. Detecting the preconditions and alerting a third party such as a lifeguard in real time, may effectively contribute to reducing drowning death toll.

Scientific researches show that preconditions for a drowning swimmer indicate a reduction of the amount of oxygen in his or her blood, a change in his or her heartbeat rate and movements of body parts having specific characteristics.

In many cases drowning conditions and pre-conditions manifest differently from one swimmer to another. Thus, drowning indicators for one person may not be considered valid for another, hence the problem of false alarm and no detection in these cases.

Several attempts have been made to provide devices that are coupled to a person's body and are arranged to detect various aspects of evolving physical conditions, in real-time.

US Publication 2004260191 which is incorporated by reference herein in its entirety discloses an exercise monitoring system which includes an electronic positioning device; a physiological monitor; and a display unit configured for displaying data provided by said electronic positioning device and said physiological monitor.

U.S. Pat. No. 6,567,004 which is incorporated by reference herein in its entirety discloses an apparatus for automatically reporting an event includes an actuator having a sensor for sensing the event and providing an actuation signal, a controller having a signal generator for formatting data corresponding to the event to form a report signal, and a transmitter for transmitting the report signal. The actuator may include a water-activated switch to sense the event or a motion detector to sense the event. The actuator may sense a signal corresponding to a change in a monitored physiological parameter of a person coupled to the apparatus

None of these attempts take into account the characteristics of a drowning person, specifically in light of the unique characterizes for drowning varying from one person to another

It would be advantageous to have a device that may detect, in real time, drowning conditions and pre-conditions of a swimmer within a body of water and further provide an alert to potential help.

### BRIEF SUMMARY

Accordingly, an aspect of the present invention, in embodiments thereof, is to provide life saving device (also referred to as: “drowning detector”), system and method arranged for detecting drowning conditions and pre-conditions in a person within a body of water (hereinafter: “a swimmer”). The device may comprise at least one movement sensor, an oximeter and a pulse sensor wherein all sensors being in direct communication with the swimmer's body and further coupled to a processing unit which is coupled in turn to a wireless data transference unit.

The movement sensors are arranged for identifying bodily movements, the oximeter is arranged for sensing oxygen level in the blood of the swimmer, the pulse sensor is arranged for sensing the heartbeat rate of the swimmer and the processing unit is arranged to process data from all sensors and determine drowning conditions and pre-conditions according to predefined parameters wherein the parameters are swimmer specific and may exhibit a learning process.

In embodiments, the present invention discloses a method of detecting and notifying of drowning conditions in a swimmer. The method comprises: optically or otherwise sensing a swimmer's body for detecting the oxygen level in his or her blood; (optionally) detecting the swimmer's movements; processing the detected characteristics and determining whether drowning conditions or pre conditions exist, in accordance with predefined patterns and optionally, in view of the swimmer's unique tracked swimming behavior.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIG.”), wherein:

FIG. 1 is a high level block diagram showing a device for detecting and notifying of drowning conditions in a swimmer according to some embodiments of the present invention;

FIG. 2 is a high level flow chart showing stages of the method according to some embodiments of the present invention; and

FIG. 3 is a high level block diagram showing a system for detecting and notifying of drowning conditions in a swimmer according to some embodiments of the present invention.

The drawings together with the description make apparent to those skilled in the art how the invention may be embodied in practice.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

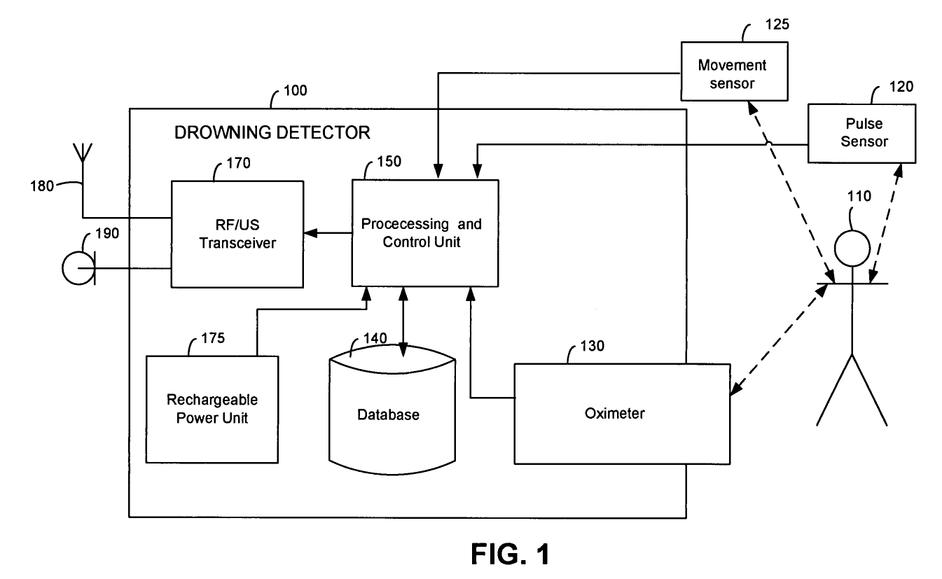

FIG. 1 shows a high level schematic block diagram of device (drowning detector) 100 for detecting drowning conditions and pre-conditions in a swimmer 110 within a body of water (not shown). Device 100 comprises: at least one movement sensor 125 attachable or in direct communication with to swimmer's body 110; an oximeter 130 attachable or in direct communication with swimmer's body 110; a pulse sensor 120 attachable or in direct communication with swimmer's body 110; a processing and control unit 150 that is coupled to movement sensor 125, pulse sensor 120, and further connected to oximeter 130. Device 100 further comprises a database 140 connected to processing and control unit 150; a Radio Frequency/Ultrasound (RF/US) transceiver 170 coupled to the processing unit 150 and further coupled to an RF antenna 180 and to a US transducer 190.

In Operation, all sensors are in direct communication with the swimmer's body. Movement sensor 125 is arranged to identify bodily movements patterns and orientation, oximeter 130 is arranged to sense oxygen level in the blood of swimmer 110, pulse sensor 120 is arranged to sense the heartbeat rate of swimmer 110 and processing unit 150 is arranged to process data from all the sensors and determine drowning conditions and pre-conditions according to predefined parameters wherein the parameters are swimmer specific and are stored in database 140. The determining of drowning conditions and pre conditions may exhibit a learning process that may be stored in database 140.

According to some embodiments, there is further provided a rechargeable power source 175 coupled to processing and control unit 170. The rechargeable power source may comprise an electromagnetic generator based upon electromagnetic inductance or any other rechargeable source that may or may not be related to the movements of the swimmer.

According to some embodiments of the invention, each movement sensor may comprise a three dimensional accelerometer, inertial gyros and the like (not shown), arranged for outputting momentary acceleration values of the swimmer's body parts.

According to some embodiments of the invention, RF/US transceiver 170 comprises a dual ultrasound and radio frequency transceiver and processing unit 150 is arranged to operate the ultrasound transceiver for underwater data transference and the radio frequency transceiver for above the water data transference respectively.

According to some embodiments database 140 is operable to store swimmer specific swimming patterns in view of the level of oxygen and heartbeat rate. This data, comprising swimming history may be used in determining drowning conditions and pre conditions.

According to some embodiments of the invention, processing unit 150 is further arranged to track the normal behavior of a swimmer and compare said normal behavior to the momentarily movements, heartbeat rate and level of oxygen in the blood of the swimmer.

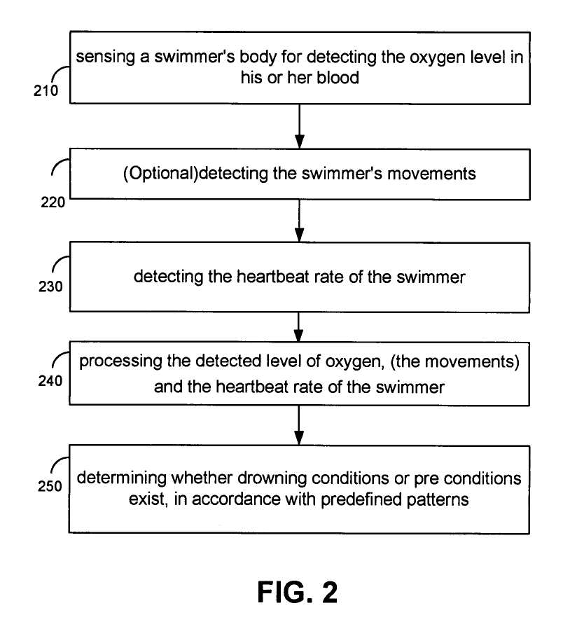

FIG. 2 is a high level flow chart showing stages of the method of detecting and notifying of drowning conditions in a swimmer according to the present invention. The method comprises: optically sensing a swimmer's body for detecting the oxygen level in his or her blood 210; (Optionally) detecting the swimmer's movements 220; detecting the heartbeat rate of the swimmer 230; processing the detected characteristics 240; and determining whether drowning conditions or pre conditions exist, in accordance with predefined patterns and optionally, swimmer's unique tracked swimming behavior 250. It should be clear that the above steps are not necessarily performed in the above order and any order of sensing, or simultaneous sensing is possible.

According to some embodiments of the invention, the disclosed method may comprise in addition to determining whether drowning conditions or pre conditions, transmitting, via a transceiver, a warning message over an ultrasound channel and/or a radio frequency channel in accordance with the location of the transceiver in relation to the body of water (underwater or above water).

According to some embodiments of the invention, the disclosed method may comprise, before determining whether drowning conditions or pre conditions exist, tracking the normal pattern of swimming of the swimmer, wherein the pattern may comprises: average level of oxygen in the blood of the swimmer, average heartbeat rate, and average movements of the swimmer.

According to some embodiments of the invention, the disclosed method may comprise determining whether drowning conditions or pre conditions exist is achieved by comparing detected level of oxygen, the movements and the heartbeat rate of the swimmer with the normal pattern of swimming of said swimmer.

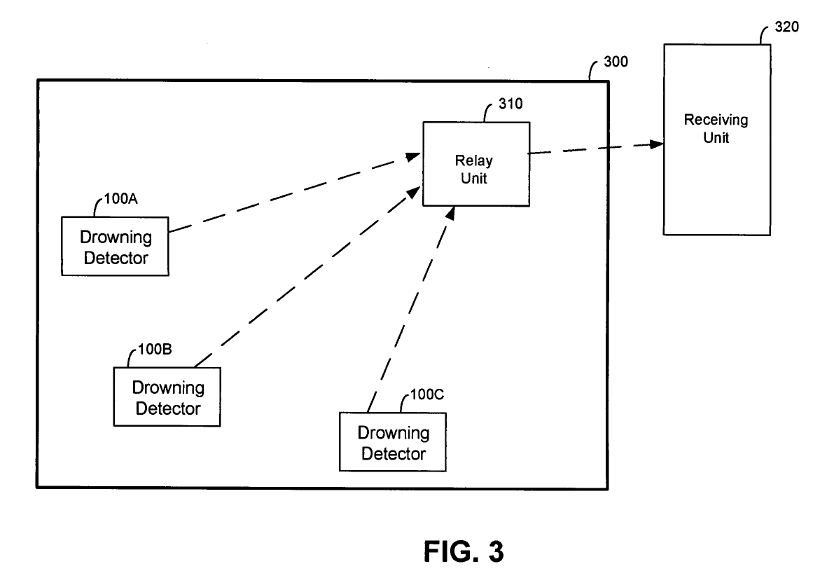

FIG. 3 shows a high level schematic block diagram of an alert system for detecting drowning conditions in swimmers (not shown) in a swimming pool 300 or any other body of water. The system comprises a plurality of devices for detecting drowning conditions (drowning detectors) 100A-C that are coupled to a third party unit such as a receiving unit 320 (one or more) that is situated near, or in communication with another system (such as an alarm system or a cellular messaging system or an Internet messaging system) or a person such as a lifeguard personnel. The system may also comprise a relay (one or more) unit 310 that is located within the pool or any other body of water, 300 and that is in direct communication with the drowning detector 100A-C and with the receiving unit 320.

According to some embodiments of the invention, drowning detector 100 may comprise all the functionality required for receiving unit 300 such that same device may be use both as a drowning detector 100 and as a receiving unit 300.

In Operation, each drowning detector 100A-C transmits alert signals upon the detection of drowning conditions in accordance with the description above.

According to some embodiments of the invention, the receiving unit 320 is further equipped with audio or visual alert means such as buzzer, sound generator, light display, and any alert system that is operatively associated with a communication network such as the Internet or a cellular phone network.

According to some embodiments of the invention, the devices 100A-C further comprises an radio frequency identification (RFID) tag (not shown) that holds information regarding the identity of the swimmer. This may be used for identification upon entering the pool or as an access restriction means.

According to some embodiments of the invention, the disclosed device further comprises a global positioning system (GPS) unit, or any other positioning system, wherein this unit is arranged to detect the physical location of the swimmer and present it for transmission via RF/US transceiver 170. Alternatively, relay unit 310 is arranged to present receiving unit 320 with location information. This may be achieved by locating a plurality of relay units 310 within pool 300 such that they are operatively associated together.

According to some embodiments of the invention, receiving unit 320 and drowning detector 100 may be arranged to be worn on the body of the swimmer or the lifeguard respectively. Alternatively, both drowning detector 100 and receiving unit 320 are implemented on the same device.

According to some embodiments of the invention, the system can be implemented in digital electronic circuitry, or in computer hardware, firmware, software, or in combinations thereof.

The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, digital signal processors (DSPs) but also general purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A device for detecting drowning conditions and pre-conditions in a swimmer within a body of water, comprising:
an oximeter;
a pulse sensor;
a processing unit; and
a transceiver coupled to the processing unit,
wherein the sensors are in direct communication with the swimmer's body and further coupled to the processing unit, and
wherein the oximeter is arranged to sense oxygen levels in blood of the swimmer, the pulse sensor is arranged to sense a heartbeat rate of the swimmer, and the processing unit is arranged to process data from the sensors and determine drowning conditions and pre-conditions according to predefined parameters.

2. The device of claim 1, further comprising at least one movement sensor in direct communication with the body of the swimmer and coupled to the processing unit,
wherein the movement sensor is arranged to identify bodily movements patterns and orientation.

3. The device of claim 1, wherein each said the movement sensor comprises a plurality of multi dimensional accelerometers arranged to output momentary acceleration values of the swimmer's body parts.

4. The device of claim 1, wherein the transceiver comprises a dual ultrasound and radio frequency transceiver, and
wherein the processing unit is arranged to operate the ultrasound transceiver for underwater data transference and the radio frequency transceiver for above the water data transference.

5. The device of claim 1, further comprising a database coupled to the processing unit, wherein the database is arranged to store swimmer specific swimming patterns in view of the level of oxygen and heartbeat rate.

6. The device of claim 1, wherein the processing unit is further arranged to track the normal behavior of a swimmer and compare the normal behavior to the sensed momentary movements, heartbeat rate and level of oxygen in the blood of the swimmer.

7. The device of claim 1, further comprising a positioning system unit arranged to detect the physical location of the swimmer and present the detected physical location for transmission via the transceiver.

8. The device of claim 1, wherein the device is operatively associated with an alert system via the transceiver.

9. The device of claim 7, wherein the alert system is operable with a plurality of devices for identifying drowning conditions.

10. The device of claim 1, further comprising a rechargeable power source that is arranged to be charged by the movements of the swimmer.

11. A method of detecting and notifying of drowning conditions in a swimmer, comprising:
sensing a swimmer's body for detecting a blood oxygen level;
detecting the swimmer's movements;
detecting a heartbeat rate of the swimmer; and
processing the detected level of oxygen, movements and heartbeat rate of the swimmer and determining whether drowning conditions or pre conditions exist, in accordance with predefined patterns.

12. The method of claim 11, wherein determining whether drowning conditions or pre conditions is followed by transmitting, via a transceiver, a warning message over an ultrasound channel or a radio frequency channel responsive of a location of the transceiver in relation to the body of water.

13. The method of claim 11, wherein determining whether drowning conditions or pre conditions exist is preceded by tracking a normal pattern of swimming of the swimmer, and
wherein the pattern comprises an average level of oxygen in the blood of the swimmer, an average heartbeat rate, or an of average movements of the swimmer.

14. The method of claim 13, wherein determining whether drowning conditions or pre conditions exist is achieved by comparing the detected level of oxygen, the movements, and the heartbeat rate of the swimmer with the normal pattern of swimming of the swimmer.

15. The method of claim 12, wherein the warning message comprises data relating to the location of the swimmer.

16. A system for detecting and notifying of drowning conditions and pre-conditions in a swimmer within a body of water, the system comprising:
at least one drowning detector comprising:
an oximeter;
a pulse sensor;
a processing unit; and
a transceiver coupled to the processing unit, wherein the sensors are in direct communication with the swimmer's body and further coupled to the processing unit, and wherein the oximeter is arranged to sense oxygen levels in the blood of the swimmer, the pulse sensor is arranged to sense the heartbeat rate of the swimmer and the processing unit is arranged to process data from the sensors and determine drowning conditions and pre-conditions according to predefined parameters; and
wherein the transceiver is arranged to transmit an alert signal upon determination of drowning condition and pre conditions;
at least one receiving unit; and
at least one relay unit,
wherein the relay unit is arranged to receive alert signals from the transceiver and deliver them to the receiving unit.

17. The system of claim 16, wherein the movement sensor comprises a plurality of multi dimensional accelerometers arranged to output momentary acceleration values of the swimmer's body parts.

18. The system of claim 16, wherein the transceiver comprises a dual ultrasound and radio frequency transceiver, and
wherein the processing unit is arranged to operate the ultrasound transceiver for underwater data transference and the radio frequency transceiver for above the water data transference.

19. The system of claim 16, wherein the receiving unit and the drowning detector are implemented together on a wearable device.

20. The system of claim 16 wherein the relay unit is further arranged to deliver data relating to a location of the swimmer to the receiving unit.
